(19) United States
(12) Patent Application Publication
(10) Pub. No.: US 2013/0183965 A1
(43) Pub. Date: Jul. 18, 2013

(54) SYSTEM AND METHOD OF OPTIMIZING USER EQUIPMENT CAMPING PROCEDURES IN CIRCUIT-SWITCHED FALLBACK

(71) Applicant: QUALCOMM Incorporated, San Diego, CA (US)

(72) Inventors: Shyamal Ramachandran, San Diego, US (US); Subbarayudu Mutya, Hyderabad (IN)

(73) Assignee: QUALCOMM INCORPORATED, San Diego, CA (US)

(21) Appl. No.: 13/738,783

(22) Filed: Jan. 10, 2013

Related U.S. Application Data
(60) Provisional application No. 61/586,528, filed on Jan. 13, 2012.

(51) Int. Cl. H04W 48/20

(52) U.S. Cl. CPC H04W 48/20
USPC 455/434; 455/435.1

(57) ABSTRACT

Certain aspects of the present disclosure provide a method for wireless communications. The method generally includes accessing, at a user equipment (UE) capable of communicating via first and second radio access technologies (RATs), a list of base stations of the first RAT, the list comprising information indicating which base stations of the first RAT support a call setup procedure for a call on at least one of the first RAT or a second RAT, and during network acquisition operations, giving preference to one or more base stations of the first RAT that, according to the list, support the call setup procedure.

### CLAIM OF PRIORITY UNDER 35 U.S.C. §119

This application claims benefit of U.S. Provisional Patent Application No. 61/586,528, filed Jan. 13, 2012, which is herein incorporated by reference in its entirety.

### BACKGROUND

1. Field

Aspects of the present disclosure relate generally to wireless communications, and more particularly, to techniques for optimizing user equipment (UE) camping procedures in circuit-switched fallback (CSFB).

2. Background

1× circuit-switched fallback (1×CSFB) is a technique to deliver voice-services to a mobile (e.g., user equipment (UE)) when the mobile is camped in a Long Term Evolution (LTE) network. This may be required when the LTE network does not support voice services natively. The LTE network and a 1× network (e.g., Code Division Mobile Access (CDMA) or Global System for Mobile (GSM)) may be connected via a connection (e.g., S102 tunnel). The UE may register with the 1× network while on the LTE network by exchanging messages with the 1× core network over the connection. When the UE receives a mobile terminated (MT) call, a mobile switching center (MSC) may deliver a 1× page to the UE over the connection. After receiving the 1× page or if a user makes a mobile originated (MO) call, the UE may inform the LTE network that the UE is leaving for a 1× call by initiating a call setup procedure. However, there may be instances where the call setup procedure may fail. For example, the UE may not be moved to the 1× network, or the UE may be moved to the 1× network but the call may fail there. Failure of the call setup procedure may affect the performance of the UE.

### SUMMARY

Certain aspects of the present disclosure provide a method for wireless communications by a user equipment (UE) capable of communicating via first and second radio access technologies (RATs). The method generally includes accessing a list of base stations of the first RAT, the list comprising information indicating which base stations of the first RAT support a call setup procedure for a call on at least one of the first RAT or the second RAT and, during network acquisition operations, giving preference to one or more base stations of the first RAT that, according to the list, support the call setup procedure.

Certain aspects of the present disclosure provide an apparatus capable of communicating via first and second radio access technologies (RATs). The apparatus generally includes means for accessing a list of base stations of the first RAT, the list comprising information indicating which base stations of the first RAT support a call setup procedure for a call on at least one of the first RAT or the second RAT, and means forgiving preference, during network acquisition operations, to one or more base stations of the first RAT that, according to the list, support the call setup procedure.

Certain aspects of the present disclosure provide an apparatus capable of communicating via first and second radio access technologies (RATs). The apparatus generally includes at least one processor configured to access a list of base stations of the first RAT, the list comprising information indicating which base stations of the first RAT support a call setup procedure for a call on at least one of the first RAT or the second RAT and give preference, during network acquisition operations, to one or more base stations of the first RAT that, according to the list, support the call setup procedure; and a memory coupled with the at least one processor.

Certain aspects of the present disclosure provide a computer program product for wireless communications by a user equipment (UE) capable of communicating via first and second radio access technologies (RATs) comprising a computer readable medium having instructions stored thereon. The instructions are generally executable by one or more processors for accessing a list of base stations of the first RAT, the list comprising information indicating which base stations of the first RAT support a call setup procedure for a call on at least one of the first RAT or the second RAT and, during network acquisition operations, giving preference to one or more base stations of the first RAT that, according to the list, support the call setup procedure.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example of a telecommunications system.

FIG. 2 is a block diagram conceptually illustrating an example of a Node B in communication with a user equipment (UE) in a telecommunications system.

FIG. 3 illustrates an example call flow of circuit-switch fallback (CSFB) when a user equipment (UE) makes a mobile originated (MO) call, according to certain aspects of the present disclosure.

FIG. 4 illustrates an example call flow of CSFB when a UE receives a mobile terminated (MT) call, according to certain aspects of the present disclosure.

FIG. 5 illustrates example operations that may be performed by a user equipment, according to an aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for providing a thorough understanding of the various concepts. However, it will be apparent to those skilled in the art that these concepts may be practiced without these specific details. In some instances, well-known structures and components are shown in block diagram form in order to avoid obscuring such concepts.

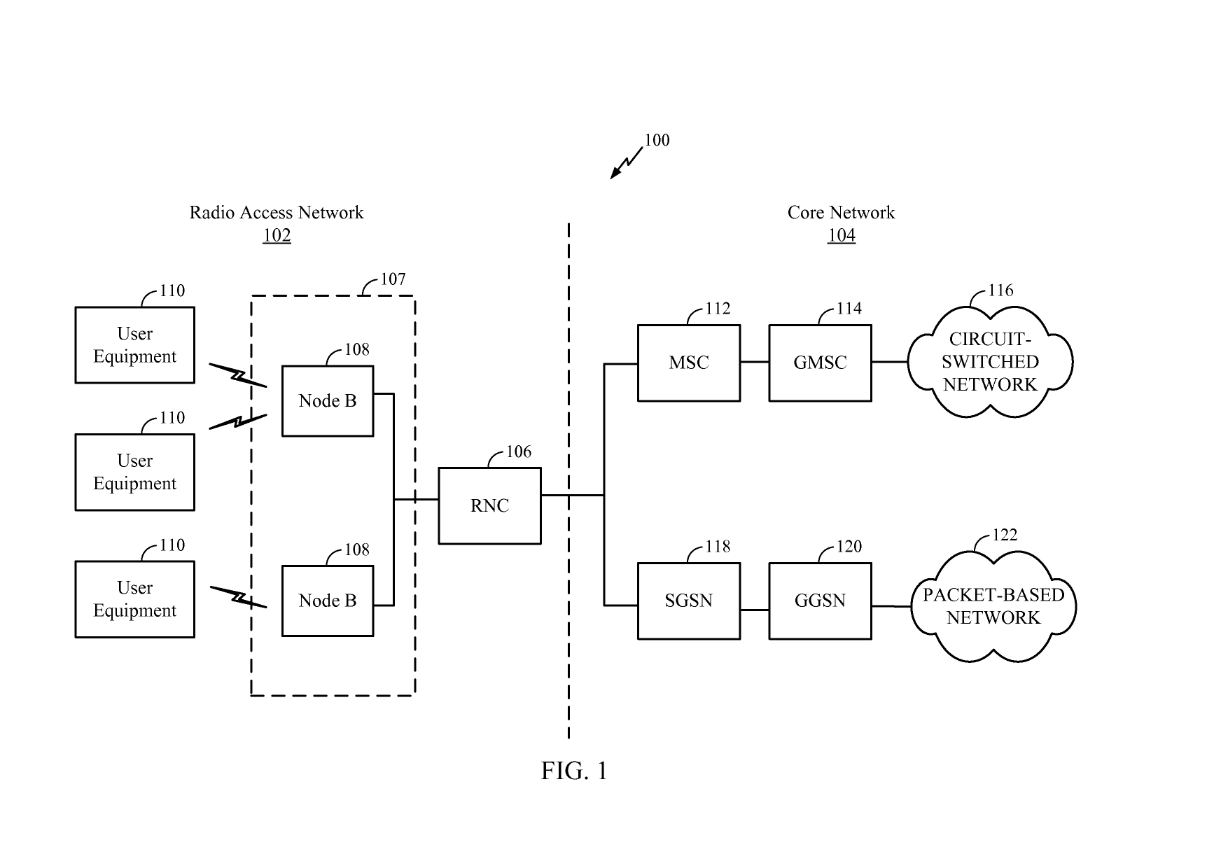

Turning now to FIG. 1, a block diagram is shown illustrating an example of a telecommunications system 100. The various concepts presented throughout this disclosure may be implemented across a broad variety of telecommunication systems, network architectures and communication standards. By way of example and without limitation, the aspects of the present disclosure illustrated in FIG. 1 are presented with reference to a Universal Mobile Telecommunication System (UMTS) employing a Time Division Synchronous Code Division Multiple Access (TD-SCDMA) standard. In this example, the UMTS system includes a radio access network (RAN) 102 (e.g., Universal Terrestrial RAN (UTRAN)) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown, however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two Node Bs 108 are shown; however, the RNS 107 may include any number of wireless Node Bs. The Node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the Node Bs 108. The downlink (DL), also called the forward link, refers to the communication link from a Node B to a UE, and the uplink (UL), also called the reverse link, refers to the communication link from a UE to a Node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. General Packet Radio Service (GPRS) is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a Node B 108 and a UE 110, but divides uplink and downlink transmissions into different time slots in the carrier.

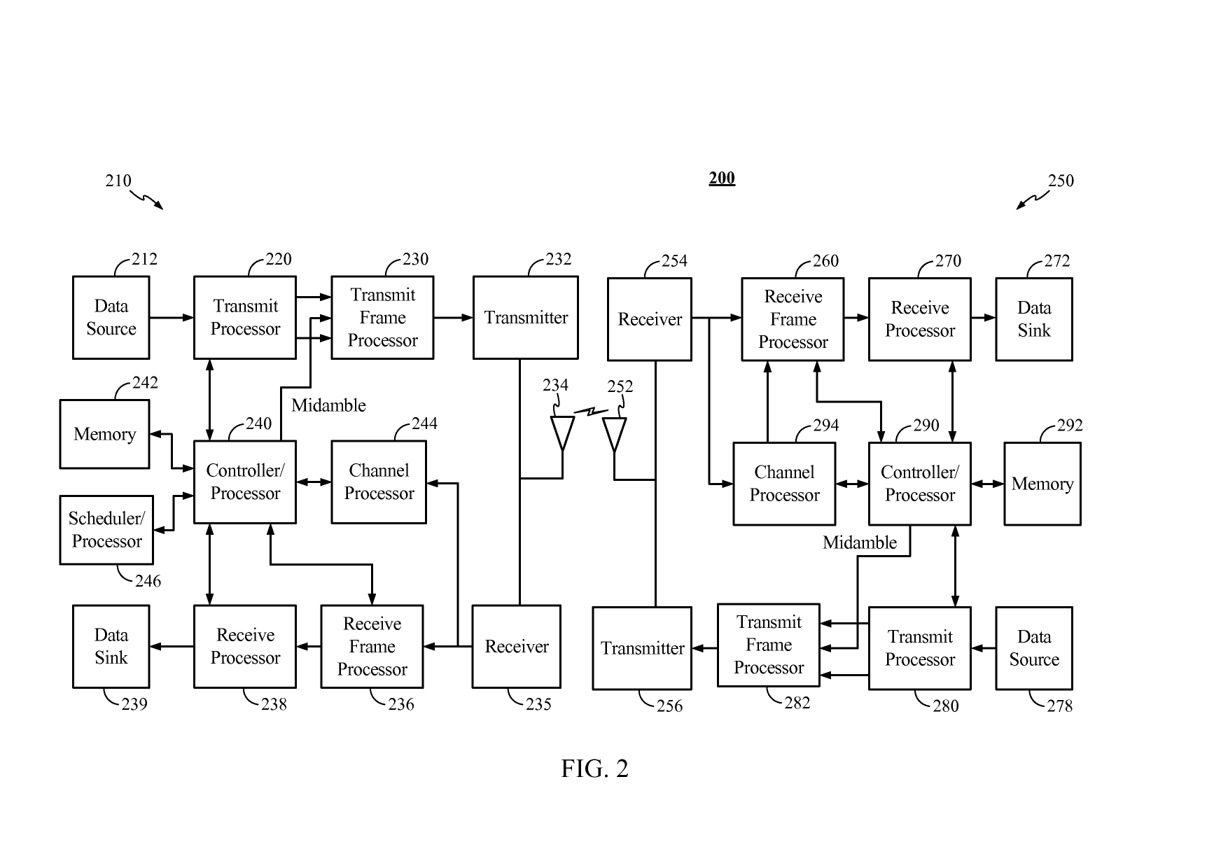

FIG. 2 is a block diagram of a Node B 210 in communication with a UE 250 in a RAN 200, where the RAN 200 may be the RAN 102 in FIG. 1, the Node B 210 may be the Node B 108 in FIG. 1 and the UE 250 may be the UE 110 in FIG. 1. In the downlink communication, a transmit processor 220 may receive data from a data source 212 and control signals from a controller/processor 240. The transmit processor 220 provides various signal processing functions for the data and control signals, as well as reference signals (e.g., pilot signals). For example, the transmit processor 220 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 244 may be used by a controller/processor 240 to determine the coding, modulation, spreading, and/or scrambling schemes for the transmit processor 220. These channel estimates may be derived from a reference signal transmitted by the UE 250 or from feedback contained in the midamble from the UE 250. The symbols generated by the transmit processor 220 are provided to a transmit frame processor 230 to create a frame structure. The transmit frame processor 230 creates this frame structure by multiplexing the symbols with a midamble from the controller/processor 240, resulting in a series of frames. The frames are then provided to a transmitter 232, which provides various signal conditioning functions including amplifying, filtering, and modulating the frames onto a carrier for downlink transmission over the wireless medium through smart antennas 234. The smart antennas 234 may be implemented with beam steering bidirectional adaptive antenna arrays or other similar beam technologies.

At the UE 250, a receiver 254 receives the downlink transmission through an antenna 252 and processes the transmission to recover the information modulated onto the carrier. The information recovered by the receiver 254 is provided to a receive frame processor 260, which parses each frame, and provides the midamble to a channel processor 294 and the data, control, and reference signals to a receive processor 270. The receive processor 270 then performs the inverse of the processing performed by the transmit processor 220 in the Node B 210. More specifically, the receive processor 270 descrambles and despreads the symbols, and then determines the most likely signal constellation points transmitted by the Node B 210 based on the modulation scheme. These soft decisions may be based on channel estimates computed by the channel processor 294. The soft decisions are then decoded and deinterleaved to recover the data, control and reference signals. The CRC codes are then checked to determine whether the frames were successfully decoded. The data carried by the successfully decoded frames will then be provided to a data sink 272, which represents applications running in the UE 250 and/or various user interfaces (e.g., display). Control signals carried by successfully decoded frames will be provided to a controller/processor 290. When frames are unsuccessfully decoded by the receiver processor 270, the controller/processor 290 may also use an acknowledgement (ACK) and/or negative acknowledgement (NACK) protocol to support retransmission requests for those frames.

In the uplink, data from a data source 278 and control signals from the controller/processor 290 are provided to a transmit processor 280. The data source 278 may represent applications running in the UE 250 and various user interfaces (e.g., keyboard). Similar to the functionality described in connection with the downlink transmission by the Node B 210, the transmit processor 280 provides various signal processing functions including CRC codes, coding and interleaving to facilitate FEC, mapping to signal constellations, spreading with OVSFs, and scrambling to produce a series of symbols. Channel estimates, derived by the channel processor 294 from a reference signal transmitted by the Node B 210 or from feedback contained in the midamble transmitted by the Node B 210, may be used to select the appropriate coding, modulation, spreading, and/or scrambling schemes. The symbols produced by the transmit processor 280 will be provided to a transmit frame processor 282 to create a frame structure. The transmit frame processor 282 creates this frame structure by multiplexing the symbols with a midamble from the controller/processor 290, resulting in a series of frames. The frames are then provided to a transmitter 256, which provides various signal conditioning functions including amplification, filtering, and modulating the frames onto a carrier for uplink transmission over the wireless medium through the antenna 252.

The uplink transmission is processed at the Node B 210 in a manner similar to that described in connection with the receiver function at the UE 250. A receiver 235 receives the uplink transmission through the antenna 234 and processes the transmission to recover the information modulated onto the carrier. The information recovered by the receiver 235 is provided to a receive frame processor 236, which parses each frame, and provides the midamble to the channel processor 244 and the data, control, and reference signals to a receive processor 238. The receive processor 238 performs the inverse of the processing performed by the transmit processor 280 in the UE 250. The data and control signals carried by the successfully decoded frames may then be provided to a data sink 239 and the controller/processor, respectively. If some of the frames were unsuccessfully decoded by the receive processor, the controller/processor 240 may also use an acknowledgement (ACK) and/or negative acknowledgement (NACK) protocol to support retransmission requests for those frames.

The controller/processors 240 and 290 may be used to direct the operation at the Node B 210 and the UE 250, respectively. For example, the controller/processors 240 and 290 may provide various functions including timing, peripheral interfaces, voltage regulation, power management and other control functions. The computer readable media of memories 242 and 292 may store data and software for the Node 210 and the UE 250, respectively. A scheduler/processor 246 at the Node B 210 may be used to allocate resources to the UEs and schedule downlink and/or uplink transmissions for the UEs.

1× circuit switched fallback (1×CSFB) is a technique to deliver voice-services to a mobile (e.g., user equipment (UE)) when the mobile is camped in an LTE network. This may be required when the LTE network does not support voice services natively. The LTE network and a 1× network (e.g., UMTS, GERAN, or CDMA2000 based networks) may be connected using an S102 tunnel. The UE may register with the 1× network while on the LTE network by exchanging messages with the 1× core network over the S102 tunnel. When the UE receives a mobile terminated (MT) call, the mobile switching center (MSC) may deliver a 1× page to the UE over the S102 tunnel. After receiving the 1× page or if a user makes a mobile originated (MO) call, the UE may inform the LTE network that the UE is leaving for a 1× call by initiating a call setup procedure.

### System and Method of Optimizing User Equipment Camping Procedures in Circuit-Switched Fallback

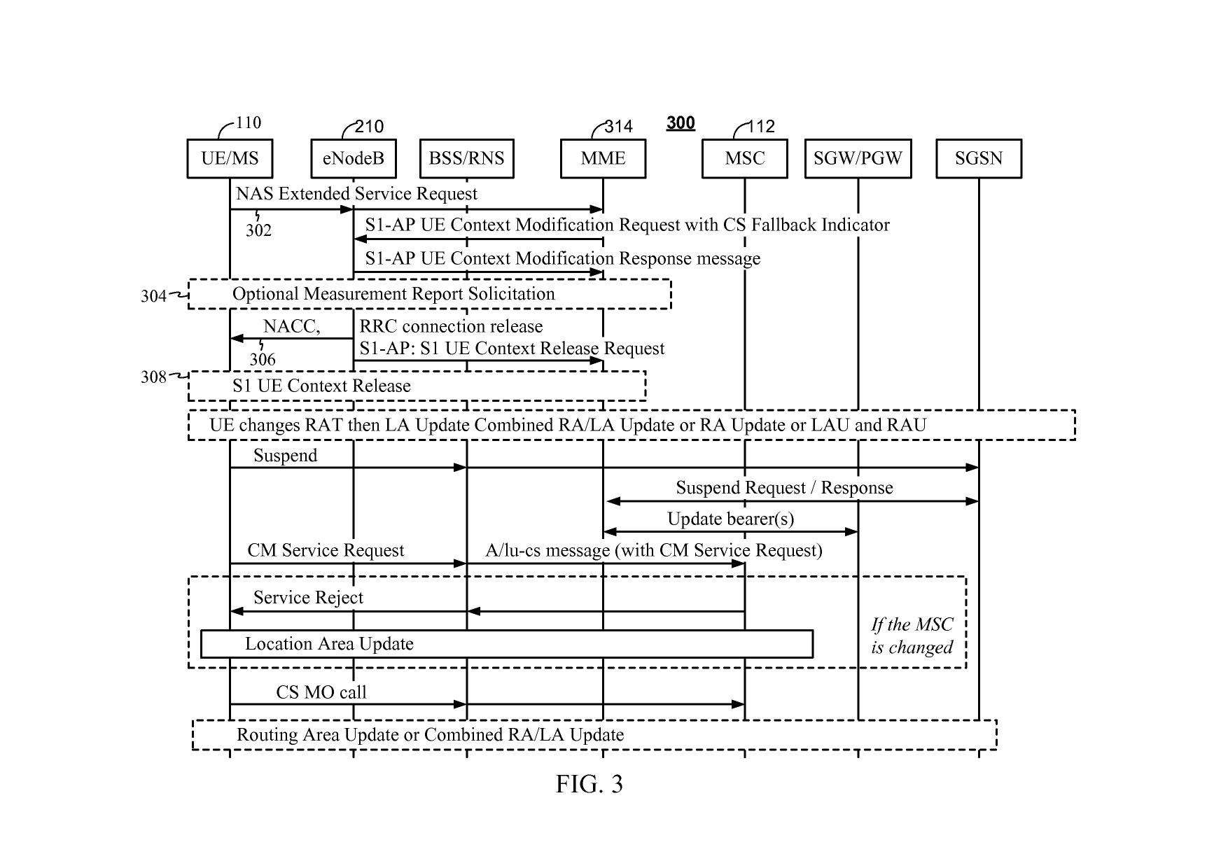

FIG. 3 illustrates an example call flow 300 of CSFB when a UE 110 (e.g., having EUTRAN/UTRAN/GERAN protocol support) makes a MO call, according to certain aspects of the present disclosure. While the UE 110 is camped on an LTE network 210 that may not support voice services, the UE 110 may need to fallback to a 1× network connected to the MSC 112 in order to make the MO call.

As shown, the call setup procedure may begin at 302 where the UE 110 may initiate a non access stratum (NAS) extended service request (ESR). At 304, the UE may receive CS RAT candidates from a measurement report. At 306, the LTE network 210 may assist the UE 110 in the mobility procedure in a network assisted cell change (NACC). For example, if an interface between the MSC 112 and the mobility management entity (MME) 314 is down, the LTE network 210 may inform the UE 110 to retry the call setup after a set period. At 308, the UE may receive a mobility command from the LTE network 210 indicating the target RAT/band/channel the UE 110 may need to tune to in order to find CS services and in order to continue with the call setup procedure.

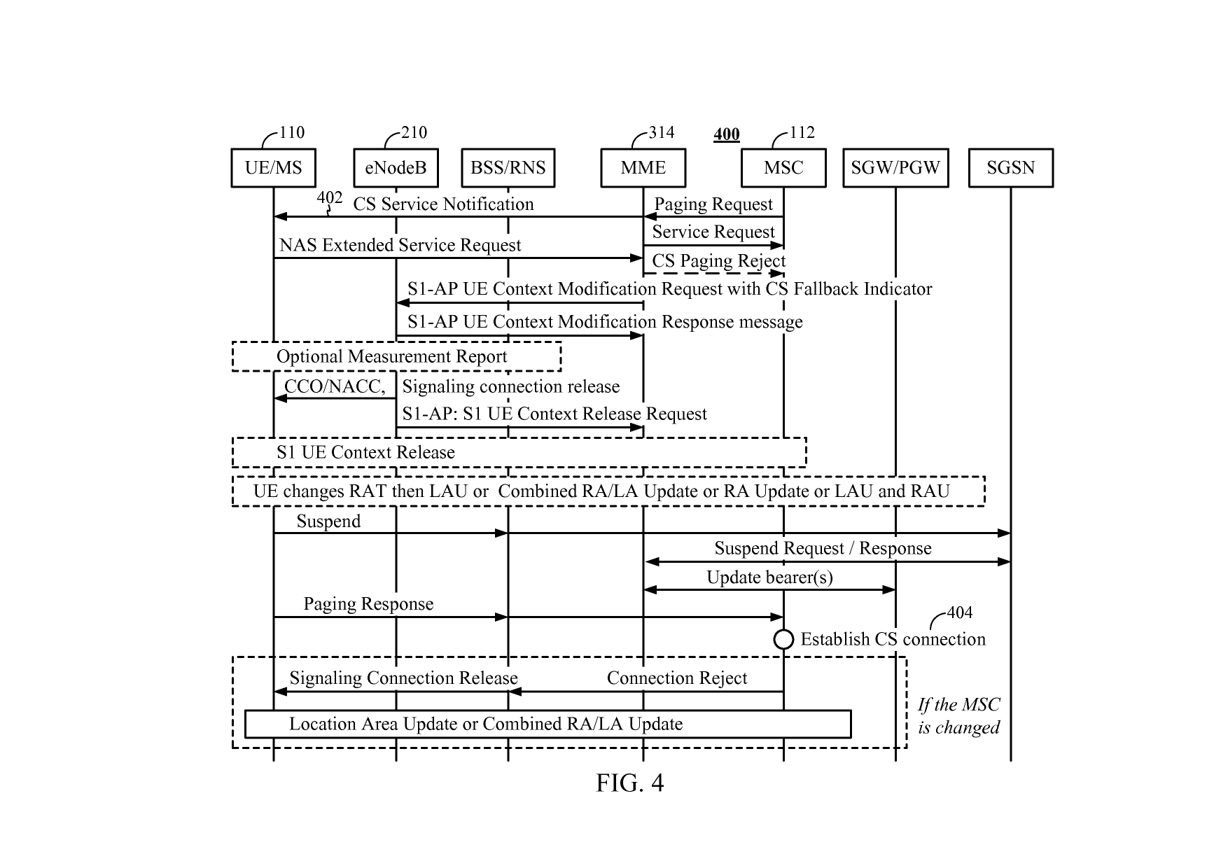

FIG. 4 illustrates an example call flow 400 of CSFB when a UE 110 receives a MT call, according to certain aspects of the present disclosure. Operations may be similar to those described in FIG. 3, however, the UE 110 may initiate the call setup procedure after receiving a 1× page at 402 (CS SERVICE NOTIFICATION). The MSC 112 may deliver the 1× page to the UE 110 (e.g., forward the page through SGs interface to MME 314). The 1× page may comprise caller line identification information.

Aspects of the present disclosure may help optimize cell selection/reselection by a UE by giving preference to one or more base stations that support desired features during cell selection and reselection procedures. This may help avoid the wasteful scenario where a UE selects a cell only to find out that desired features are not supported.

For some embodiments, when a user dials a number to place a CS call (i.e. MO call), if the UE were camped on an LTE network, the CSFB procedure may be employed, as illustrated in FIG. 3. This procedure may move the UE from the LTE network (e.g., E-UTRAN) to a 1× network (e.g., UTRAN/GERAN/1×RTT) where CS call setup may occur using legacy CS call setup procedures. If the mobility management entity (MME) or the tracking area (TA) in which the UE is located supports CSFB features, the base station may move the UE to the 1× network, so that UE may perform the CS call on the 1× network.

However, if the CSFB features are not supported by the TA or MME in which UE is registered, then UE may be rejected during tracking area update (TAU), attach, or extended service request (ESR) procedures. For example, referring back to FIG. 3, when UE 110 initiates an ESR at 202, the request may be rejected. For some embodiments of the present disclosure, a UE may give preference to one or more base stations that support CSFB features during cell selection and reselection procedures.

A UE, after camping on an LTE network following a cell selection criteria may perform attempts for registration for evolved packet system (EPS) or non-EPS services for enabling CSFB support. If the UE is required to find a base station or a TA that supports CSFB or internet protocol multimedia subsystem (IMS) voice over IP, the UE may trigger a cell selection procedure in LTE and select an appropriate cell and attempt combined attach or TAU procedures. However, before attempting the cell selection/reselection procedure and combined attach/TAU procedures, the UE may not know whether any particular cell is CSFB/VoIP capable.

For some embodiments, the UE may maintain internally (e.g., in a database stored in memory), information about cells in the TA that support CSFB. The UE may use this information further during LTE camping procedures and cell selection/reselection procedures. For example, after accessing the database, if the UE determines that a particular LTE cell does not support CSFB procedures, the UE may not give preference to the particular LTE cell during network acquisition operations.

For some embodiments, when a UE attempts an attach/TAU request for combined EPS and non-EPS services, the UE may receive an acceptance of the request with the EPS attach result as EPS only when the attempt made by the UE is not successful for CSFB. Similarly, network support of IMS voice over PS may be indicated by acceptance messages from the LTE network.

Example of parameters that the UE may store per TA or TA list include, but are not limited to, a CSFB support indicator and an IMS Voice over PS indicator. The UE may maintain a set of parameters internally (e.g., 3GPP_CSFB_ALLOWED, 3GPP_CSFB_PREF, VOICE_IMS_ALLOWED, SMS_NAS_ALLOWED). In some cases, there may be an explicit indication of support for IMS emergency calls. For some embodiments, the parameters may be updated (or added) when an acceptance message is received from the network. For some embodiments, the UE may maintain, per TA or list of TAs, if cells belonging to the LTE network can support CSFB to 3 GPP or CSFB to 3 GPP2.

For some embodiments, although certain cells may support CSFB procedures, a user may still experience failures due to, for example, congestion in the network. The UE may determine to set the above-described variables to false. For some embodiments, the UE may determine whether to consider these failures while using these cells for LTE cell selection and reselection purposes.

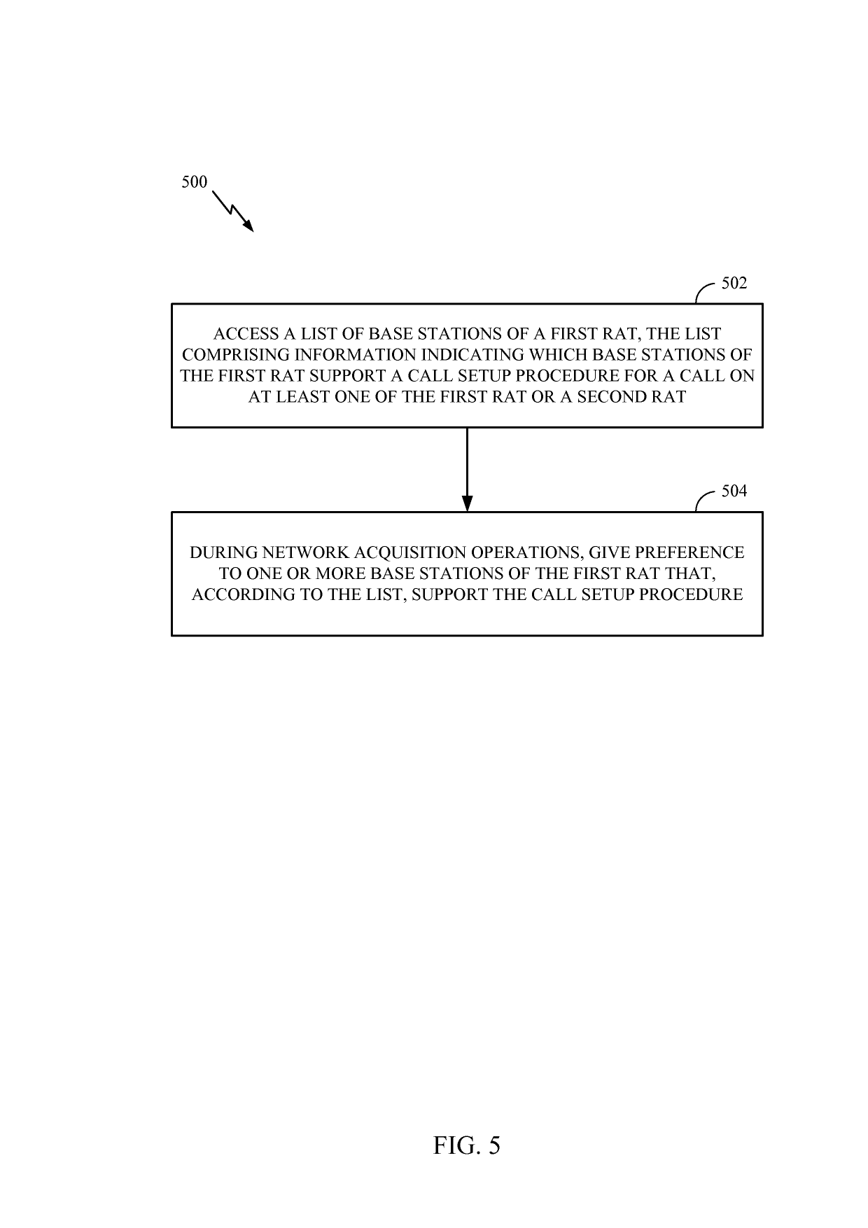

FIG. 5 illustrates example operations 500 in accordance with certain aspects of the present disclosure. The operations 500 may be performed from, for example, the perspective of a UE capable of communicating via first and second radio access technologies (RATs).

At 502, the UE may access a list of base stations of the first RAT, the list comprising information indicating which base stations of the first RAT support a call setup procedure for a call on at least one of the first RAT or a second RAT. The information may comprise, for example, a circuit-switched fallback (CSFB) support indicator (for a call setup on the second RAT or UMTS) or IMS voice over PS (internet protocol multimedia subsystem voice over packet switched) indicator (for a call setup on the first RAT or LTE).

At 504, the UE, during network acquisition operations, may give preference to one or more base stations of the first RAT that, according to the list, support the call setup procedure. For some embodiments, the list may be updated based on information received over the air.

Several aspects of a telecommunications system has been presented with reference to a 1× and LTE system. As those skilled in the art will readily appreciate, various aspects described throughout this disclosure may be extended to other telecommunication systems, network architectures and communication standards.

By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for wireless communications by a user equipment (UE) capable of communicating via first and second radio access technologies (RATs), comprising:
accessing a list of base stations of the first RAT, the list comprising information indicating which base stations of the first RAT support a call setup procedure for a call on at least one of the first RAT or the second RAT; and
during network acquisition operations, giving preference to one or more base stations of the first RAT that, according to the list, support the call setup procedure.

2. The method of claim 1, wherein the information indicates one or more base stations as not supporting a call setup procedure due to one or more observed performance issues.

3. The method of claim 1, wherein the information comprises a circuit-switched fallback (CSFB) support indicator or internet protocol multimedia subsystem (IMS) voice over packet switched (PS) indicator.

4. The method of claim 1, wherein the first RAT comprises a Long Term Evolution (LTE) RAT.

5. The method of claim 1, wherein the second RAT comprises at least one of a Code Division Multiple Access (CDMA) RAT and a Global System for Mobile (GSM) RAT.

6. The method of claim 1, further comprising:
updating the list based on information received over the air.

7. An apparatus capable of communicating via first and second radio access technologies (RATs), comprising:
means for accessing a list of base stations of the first RAT, the list comprising information indicating which base stations of the first RAT support a call setup procedure for a call on at least one of the first RAT or the second RAT; and
means for giving preference, during network acquisition operations, to one or more base stations of the first RAT that, according to the list, support the call setup procedure.

8. The apparatus of claim 7, wherein the information indicates one or more base stations as not supporting a call setup procedure due to one or more observed performance issues.

9. The apparatus of claim 7, wherein the information comprises a circuit-switched fallback (CSFB) support indicator or internet protocol multimedia subsystem (IMS) voice over packet switched (PS) indicator.

10. The apparatus of claim 7, wherein the first RAT comprises a Long Term Evolution (LTE) RAT.

11. The apparatus of claim 7, wherein the second RAT comprises at least one of a Code Division Multiple Access (CDMA) RAT and a Global System for Mobile (GSM) RAT.

12. The apparatus of claim 7, further comprising:
means for updating the list based on information received over the air.

13. An apparatus capable of communicating via first and second radio access technologies (RATs), comprising:
at least one processor configured to access a list of base stations of the first RAT, the list comprising information indicating which base stations of the first RAT support a call setup procedure for a call on at least one of the first RAT or the second RAT and give preference, during network acquisition operations, to one or more base stations of the first RAT that, according to the list, support the call setup procedure; and
a memory coupled with the at least one processor.

14. The apparatus of claim 13, wherein the information indicates one or more base stations as not supporting a call setup procedure due to one or more observed performance issues.

15. The apparatus of claim 13, wherein the information comprises a circuit-switched fallback (CSFB) support indicator or internet protocol multimedia subsystem (IMS) voice over packet switched (PS) indicator.

16. The apparatus of claim 13, wherein the first RAT comprises a Long Term Evolution (LTE) RAT.

17. The apparatus of claim 13, wherein the second RAT comprises at least one of a Code Division Multiple Access (CDMA) RAT and a Global System for Mobile (GSM) RAT.

18. The apparatus of claim 13, wherein the at least one processor is configured to update the list based on information received over the air.

19. A computer program product for wireless communications by a user equipment (UE) capable of communicating via first and second radio access technologies (RATs) comprising a computer readable medium having instructions stored thereon, the instructions executable by one or more processors for:
accessing a list of base stations of the first RAT, the list comprising information indicating which base stations of the first RAT support a call setup procedure for a call on at least one of the first RAT or the second RAT; and
during network acquisition operations, giving preference to one or more base stations of the first RAT that, according to the list, support the call setup procedure.

20. The computer program product of claim 19, wherein the information indicates one or more base stations as not supporting a call setup procedure due to one or more observed performance issues.

21. The computer program product of claim 19, wherein the information comprises a circuit-switched fallback (CSFB) support indicator or internet protocol multimedia subsystem (IMA) voice over packet switched (PS) indicator.

22. The computer program product of claim 19, wherein the first RAT comprises a Long Term Evolution (LTE) RAT.

23. The computer program product of claim 19, wherein the second RAT comprises at least one of a Code Division Multiple Access (CDMA) RAT and a Global System for Mobile (GSM) RAT.

24. The computer program product of claim 19, further comprising:
updating the list based on information received over the air.

25. A method for wireless communications by a user equipment (UE) capable of communicating via first and second radio access technologies (RATs), comprising:
identifying a plurality of base stations of the first RAT which support a call setup procedure for a call on at least one of the first RAT or a second RAT; and
during network acquisition operations, giving preference to the identified plurality of base stations.

26. The method of claim 25, wherein identifying the plurality of base stations further comprises not identifying base stations that have performance issues.
